(19) United States
(12) Patent Application Publication
(10) Pub. No.: US 2026/0081423 A1
(43) Pub. Date: Mar. 19, 2026

(54) ANALYZING SUB-SYNCHRONOUS OSCILLATIONS IN A POWER SYSTEM

(71) Applicant: Schneider Electric USA, Inc., Boston, MA (US)

(72) Inventors: David Thomas TUCKEY, Victoria (CA); Jon A. BICKEL, Murfreesboro, TN (US)

(21) Appl. No.: 19/274,035

(22) Filed: Jul. 18, 2025

Related U.S. Application Data
(60) Provisional application No. 63/695,672, filed on Sep. 17, 2024.

(51) Int. Cl. H02J 3/24; H02J 3/00

(52) U.S. Cl. CPC H02J 3/00142; H02J 3/0012; H02J 2103/35

(57) ABSTRACT

Detection of sub-synchronous oscillations in an electrical system for identifying, quantifying, and mitigating grid issues associated with large and fast load fluctuations. An Intelligent Electronic Device (IED) of an electrical system detects energy-related signals associated with the electrical system and processes the energy-related data to identify non-harmonic frequencies of interest. Values associated with the identified one or more non-harmonic frequencies of interest are quantified as a function of at least one of power, voltage, and current data. An alert representative of the quantified values exceeding a set of predefined magnitude limits for longer than a threshold duration may be generated.

### FIELD

The present disclosure relates generally to electrical/power systems, and more particularly, to systems and methods for analyzing and assessing energy-related data in an electrical system.

### BACKGROUND

Sub-synchronous frequencies can be associated with and/or caused by the operation of large customer loads. One example is substantial high-frequency cycling of Data Center loads that use or otherwise employ or manage artificial intelligence (AI) processes. Large high-speed load swings can induce non-harmonic frequencies onto the power grid, potentially leading to a local (or even larger) area destabilization of the power grid. Distributed energy resources may exacerbate or be impacted by the induced operational load profile of Data Centers employing these AI processes and the like.

### SUMMARY

Aspects of the present disclosure identify and quantify sub-synchronous frequencies associated with and/or caused by the operation of large customer loads and help to identify, quantify, and mitigate grid issues associated with large and/or high-frequency load fluctuations.

In an aspect, a method for detecting sub-synchronous oscillations in an electrical system comprises acquiring, by at least one IED connected to an electrical system, energy-related signals associated with the electrical system and processing the energy-related data to identify one or more non-harmonic frequencies of interest. Non-harmonic frequencies comprise, for instance, non-integer multiples of the fundamental frequency, and may also be referred to as inter-harmonics, or in special cases, sub-harmonics. Sub-harmonics are a subset of non-harmonics that are sub-fundamental frequency(s), that is below the power system's fundamental frequency (i.e., typically below 50 Hertz or 60 Hertz). In response to the processing, the method includes quantifying values associated with the identified one or more non-harmonic frequencies of interest as a function of at least one of power, voltage, or current data and executing a power flow analysis of the quantified values to determine a characteristic of the identified one or more non-harmonic frequencies of interest relative to the physical location of the IED's installation. This method further includes executing a mitigative action in response to the quantified values exceeding a set of predefined magnitude limits for longer than a threshold duration. In one embodiment, the mitigative action may be an alert indicating and/or including aspects related to or associated with a magnitude(s), directional flow(s), frequency(s), or other characteristic(s) of one or more non-harmonic frequencies of interest.

In another aspect, a system for detecting sub-synchronous oscillations comprises at least one IED, which is communicatively coupled to an electrical system and configured to acquire energy-related signals associated with the electrical system. The system also includes a meter processor receiving and responsive to the energy-related signals acquired by the at least one IED and a memory coupled to the meter processor. The memory stores processor-executable instructions that, when executed, configure the meter processor to process the energy-related data to identify one or more non-harmonic frequencies of interest in the energy-related signals and, in response to identifying the one or more non-harmonic frequencies of interest, quantify values associated with the identified one or more non-harmonic frequencies of interest as a function of at least one of power, voltage, or current data in the energy-related signals. For example, the quantified values may include some combination of magnitude, direction, and discrete frequency of interest. The memory also stores processor-executable instructions that, when executed, further configure the meter processor to execute a power flow analysis of the quantified values to determine a characteristic of the identified one or more non-harmonic frequencies of interest relative to the IED and execute a mitigative action in response to the quantified values exceeding a set of predefined magnitude limits for longer than a duration threshold.

Other aspects, advantages, and features of the present disclosure will be in part apparent and in part specified herein.

### BRIEF DESCRIPTION OF THE DRAWINGS

FIG. 1 illustrates an exemplary electrical system in accordance with embodiments of the disclosure.

FIG. 2 illustrates another exemplary electrical system in accordance with embodiments of the disclosure.

FIG. 3A illustrates an example of an electrical system in which a non-harmonic source is located upstream of a point-of-common coupling (PCC) in accordance with embodiments of the disclosure.

FIG. 3B illustrates an example of an electrical system in which a non-harmonic source is located downstream of a PCC in accordance with embodiments of the disclosure.

FIG. 4A illustrates an example of upstream non-harmonic power flows in accordance with embodiments of the disclosure.

FIG. 4B illustrates an example of downstream non-harmonic power flows in accordance with embodiments of the disclosure.

FIG. 4C illustrates another example of upstream non-harmonic power flows in accordance with embodiments of the disclosure.

FIG. 4D illustrates another example of downstream non-harmonic power flows in accordance with embodiments of the disclosure.

FIG. 5 illustrates an example process of identifying and quantifying non-synchronous frequencies in an electrical system in accordance with embodiments of the disclosure.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

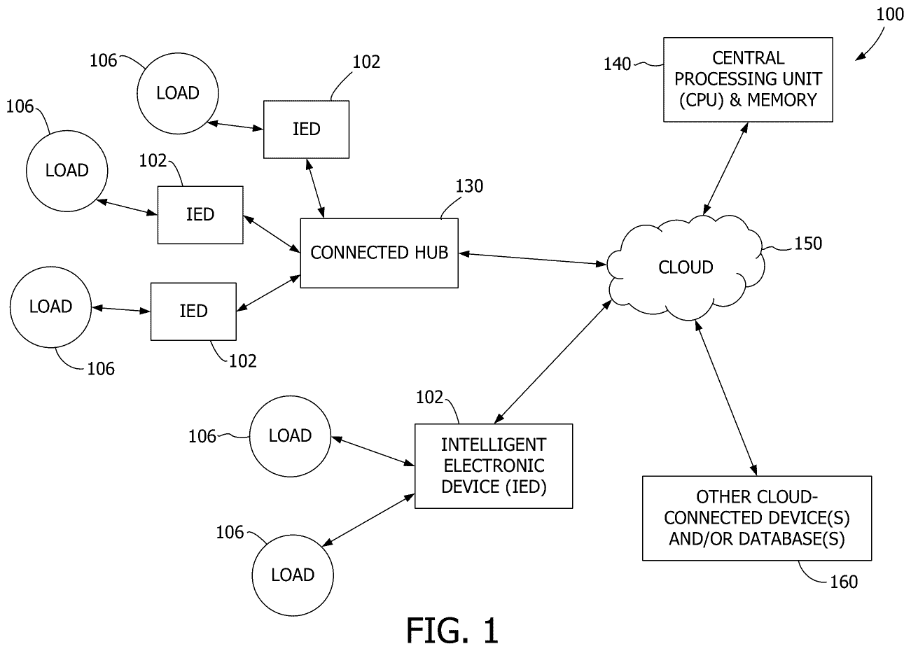

Aspects of the present disclosure identify and quantify sub-synchronous frequencies associated with and/or caused by the operation of large customer loads and help to identify, quantify, and mitigate grid issues associated with large and fast load fluctuations. Referring to FIG. 1, an example electrical system 100 in accordance with embodiments of the disclosure includes one or more intelligent electronic devices (IEDs) 102 capable of sampling, sensing, or monitoring one or more parameters (e.g., power monitoring parameters) associated with one or more loads 106 (also sometimes referred to herein as “equipment” or “apparatuses”). Although indicated with the same reference numeral, it is to be understood that the IEDs 102 may differ from each other (e.g., IEDs with different features and capabilities, etc.) and loads 106 may differ from each other (e.g., motors, lighting, computer servers, etc.) depending on the specific design and features of the electrical system 100. In embodiments, loads 106 and IEDs 102 may be installed in one or more buildings or other physical locations or they may be installed on one or more processes and/or loads within a building. The buildings may correspond, for example, to commercial, industrial, or institutional buildings.

As shown in FIG. 1, IEDs 102 are each coupled to one or more of the loads 106, which may be located “upline/upstream” or “downline/downstream” from the IEDs in some embodiments. The loads 106 include, for example, machinery or apparatuses associated with a particular application (e.g., an industrial application), applications, and/or process(es). The machinery may include electrical or electronic equipment, for example. The machinery may also include the controls and/or ancillary equipment associated with the equipment. In accordance with aspects of the present disclosure, loads 106 comprise a mix of single-phase and three-phase loads (e.g., motors).

In embodiments, IEDs 102 may monitor and, in some embodiments, analyze parameters (e.g., energy-related parameters) associated with loads 106 to which they are coupled. For instance, IED 102 (e.g., a metering device) captures energy-related waveforms in electrical system 100. As used herein, an IED is a computational electronic device optimized to perform a particular function or set of functions. Examples of IEDs 102 include smart utility meters, power quality meters, microprocessor relays, digital fault recorders, and other metering devices. The IEDs 102 may also be embedded in variable speed drives (VSDs), uninterruptible power supplies (UPSs), circuit breakers, relays, transformers, or any other electrical apparatus. In addition, IEDs 102 may be used to perform measurement/monitoring and control functions in a wide variety of installations. The installations may include utility systems, industrial facilities, warehouses, office buildings or other commercial complexes, campus facilities, computing co-location centers, data centers, power distribution networks, or any other structure, process or load that uses electrical energy. For example, where IED 102 is an electrical power monitoring device, it may be coupled to (or be installed in) an electrical power transmission or distribution system and configured to sense/measure and store data (e.g., waveform data, logged data, I/O data, etc.) as electrical parameters representing operating characteristics (e.g., voltage, current, waveform distortion, power, etc.) of the electrical distribution system. These parameters and characteristics may be analyzed by a user to evaluate potential performance, reliability and/or power quality-related issues, for example. One or more of the IEDs 102 may include at least a controller (which in certain IEDs can be configured to run one or more applications simultaneously, serially, or both), firmware, a memory, a communications interface, and connectors that connect the IED to external systems, devices, and/or components at any voltage level, configuration, and/or type (e.g., AC, DC). At least certain aspects of the monitoring and control functionality of IED 102 may be embodied in a computer program that is accessible by the IED.

In some embodiments, the term “IED” as used herein may refer to a hierarchy of IEDs operating in parallel and/or tandem (series). For example, an IED may correspond to a hierarchy of energy meters, power meters, and/or other types of resource meters. The hierarchy may comprise a tree-based hierarchy, such a binary tree, a tree having one or more child nodes descending from each parent node or nodes, or combinations thereof, wherein each node represents a specific IED. In some instances, the hierarchy of IEDs may share data or hardware resources and may execute shared software. It is understood that hierarchies may be non-spatial such as billing hierarchies where IEDs grouped together may be physically unrelated.

According to another aspect, IEDs 102 may detect overvoltage and undervoltage conditions (e.g., transient overvoltages), as well as other parameters such as temperature, including ambient temperature. According to a further aspect, IEDs 102 may provide indications of monitored parameters and detected conditions that can be used to control loads 106 and other equipment in the electrical system 100 in which loads 106 and IEDs 102 are installed. A wide variety of other monitoring and/or control functions can be performed by IEDs 102 and the aspects and embodiments disclosed herein are not limited to IEDs 102 operating as described in the above-mentioned examples.

It is to be understood that IEDs 102 may take various forms and may each have an associated complexity (or set of functional capabilities and/or features). For example, one IED 102 is a “basic” IED while another IED 102 is an “intermediate” IED and yet another IED 102 is an “advanced” IED. In such embodiments, the intermediate IED may have more functionality (e.g., energy measurement features and/or capabilities) than the basic IED, and advanced IED may have more functionality and/or features than both the intermediate IED and the basic IED. For example, in embodiments IED 102 (e.g., an IED with basic capabilities and/or features) may be capable of monitoring instantaneous voltage, current energy, demand, power factor, averages values, maximum values, instantaneous power, and/or long-duration rms variations and/or IED 102 (e.g., an IED with advanced capabilities) may be capable of monitoring additional parameters such as voltage transients, voltage fluctuations, frequency slew rates, harmonic power flows, and discrete harmonic components, all at higher sample rates, etc. It is understood that this example is for illustrative purposes only, and likewise in some embodiments an IED with basic capabilities may be capable of monitoring one or more of the above energy measurement parameters that are indicated as being associated with an IED with advanced capabilities. It is also understood that in some embodiments the IEDs 102 each have independent functionality.

In the example embodiment of FIG. 1, IEDs 102 are communicatively coupled to a central processing unit (CPU) 140 (and associated memory) via a data communications network shown as “cloud” 150. In some embodiments, IEDs 102 may be directly communicatively coupled to the cloud 150. In other embodiments, IEDs 102 may be indirectly communicatively coupled to cloud 150 via, for example, an intermediate device such as a connected hub 130 (or a gateway) providing IEDs 102 with access to cloud 150 and CPU 140. Additional cloud-connected devices and/or databases are indicated at reference character 160.

Commonly assigned U.S. Pat. No. 11,853,095, the entire disclosure of which is incorporated herein by reference, discloses a cloud-connected electrical system in which aspects of the present disclosure may be used.

The source of a disturbance may be determined as being “downstream” or “downline” (toward the electrical loads that utilize the electrical power) or “upstream” or “upline” (toward the source of electrical power itself). For a network, transmission system, or any other non-radial fed system, the supply of electric power may be ambiguous because of multiple sources or electrical paths. In those cases, “forward” and “reverse” may be used to describe relative direction of a disturbance source.

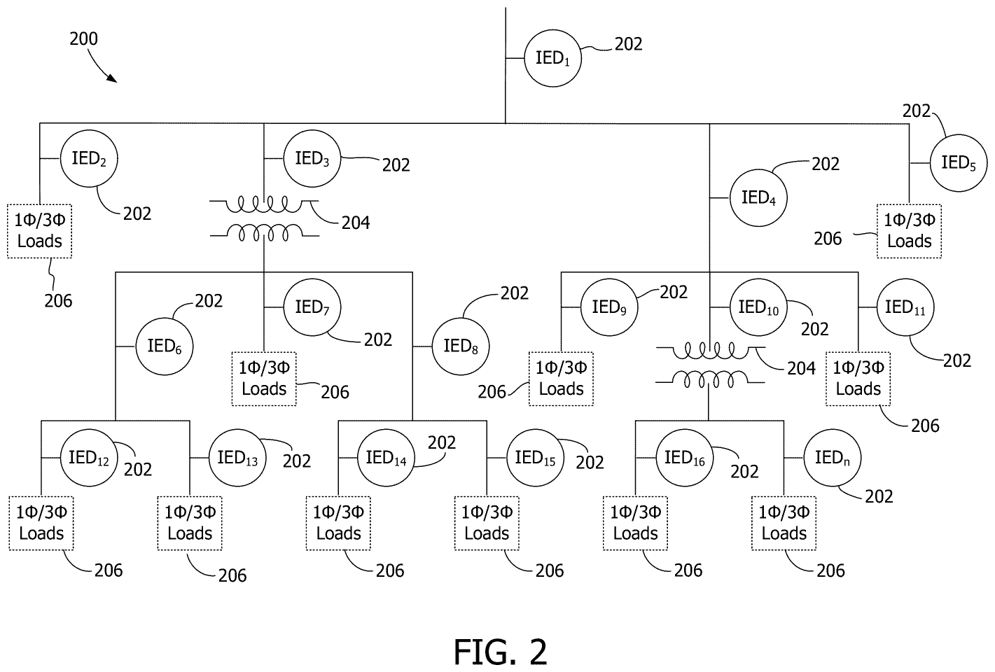

FIG. 2 illustrates another example electrical system 200 for which aspects of the present disclosure may be used to automatically assess voltage unbalance. One or more embodiments may optionally use location information of one or more IEDs 202 within the electrical system 200 to provide spatial context. For example, FIG. 2 illustrates system 200 that is radial-fed, includes two step-down transformers 204, and has multiple IEDs 202 monitoring a mix of single-phase and three-phase downstream loads 206. It is to be understood that the electrical system 200 of FIG. 2 is just one embodiment of many potential embodiments to teach the concepts described herein.

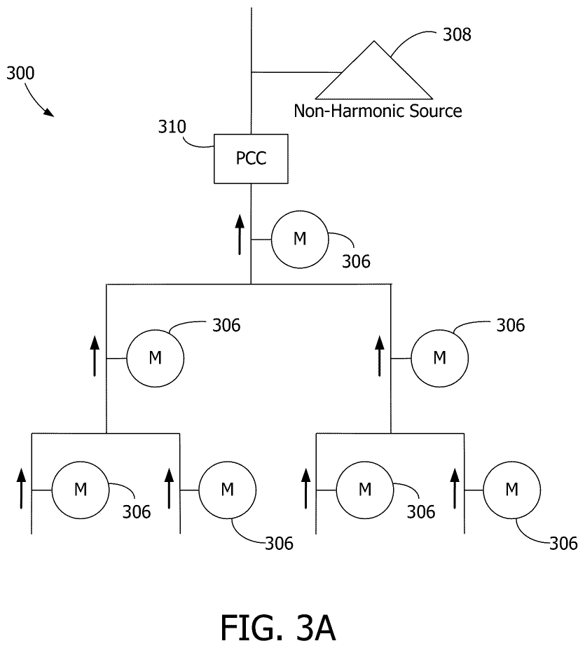

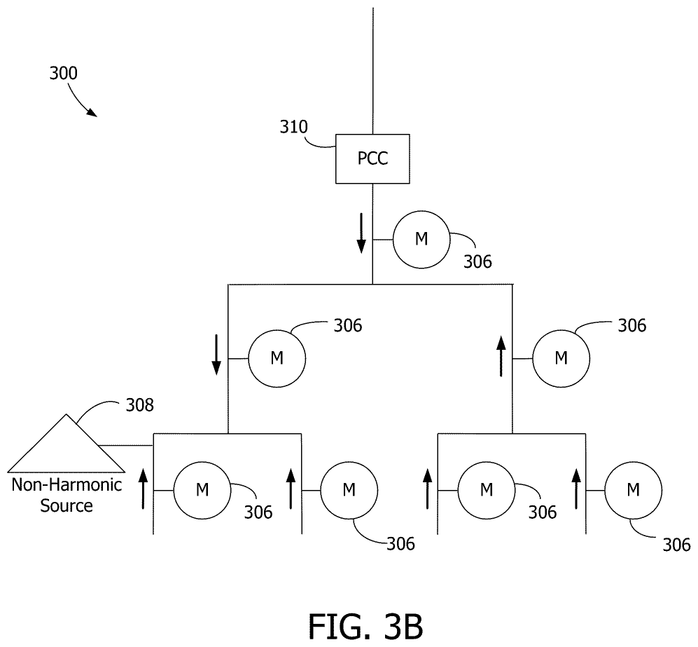

Referring now to FIGS. 3A and 3B, aspects of the present disclosure permit determining non-harmonic source(s) locations in an electrical power system, such as an example electrical system 300. In this regard, aspects of the present disclosure determine the upstream or downstream direction of non-harmonic power flows for oscillations, such as those resulting from substantial high frequency cycling of Data Center loads or the like.

The disclosure outlined herein allows a device that measures electrical parameters to determine whether the non-harmonic source(s) are upstream or downstream from the installation point of the device. In an embodiment, the “device” is any electrical system element or apparatus with the ability to sample, collect, or measure the operational characteristics and parameters of the electrical system to which it is connected. The device is configured to ascertain whether such a source is upstream or downstream from the point at which the device is attached and measuring parameters on an electrical power system. According to one or more embodiments, IEDs 102 are suitable devices for measuring electrical parameters on the electrical system 300 to determine whether the source(s) are upstream or downstream. The IEDs 102 are capable of sampling, sensing, or monitoring one or more parameters (e.g., power monitoring parameters) associated with one or more loads 306 of electrical system 300 as shown in FIGS. 3A and 3B to determine source locations. Aspects of the present disclosure also permit multiple devices, or IEDs, to pinpoint the source or sources of non-harmonic power flows for oscillations more specifically within the electrical power system.

Using multiple devices throughout a power system will allow the user to determine the location of non-harmonic sources within the electrical power system. By analyzing both the non-harmonic source directional information and ensuring the non-harmonic frequency information is compatible from each device on the power system that can perform the required algorithms), the monitoring system software can accurately determine the location of the non-harmonic source within the power system. As examples, FIG. 3A illustrates the exemplary electrical system 300 in which a non-harmonic source 308 is located upstream of a point-of-common coupling (PCC) 310 and FIG. 3B illustrates the exemplary electrical system 300 in which the non-harmonic source 308 is located within a facility downstream of PCC 310.

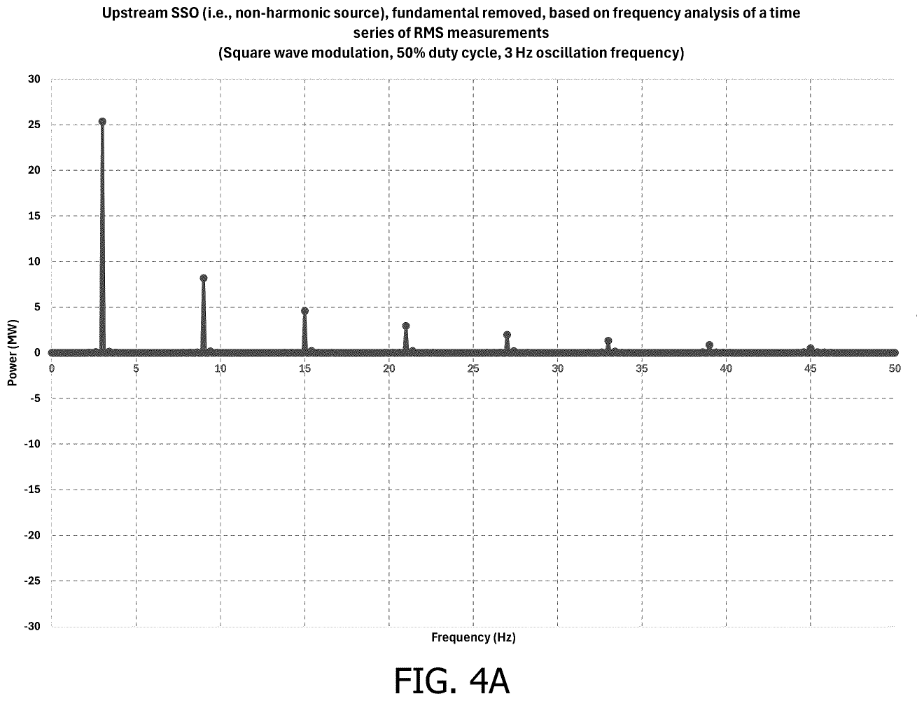

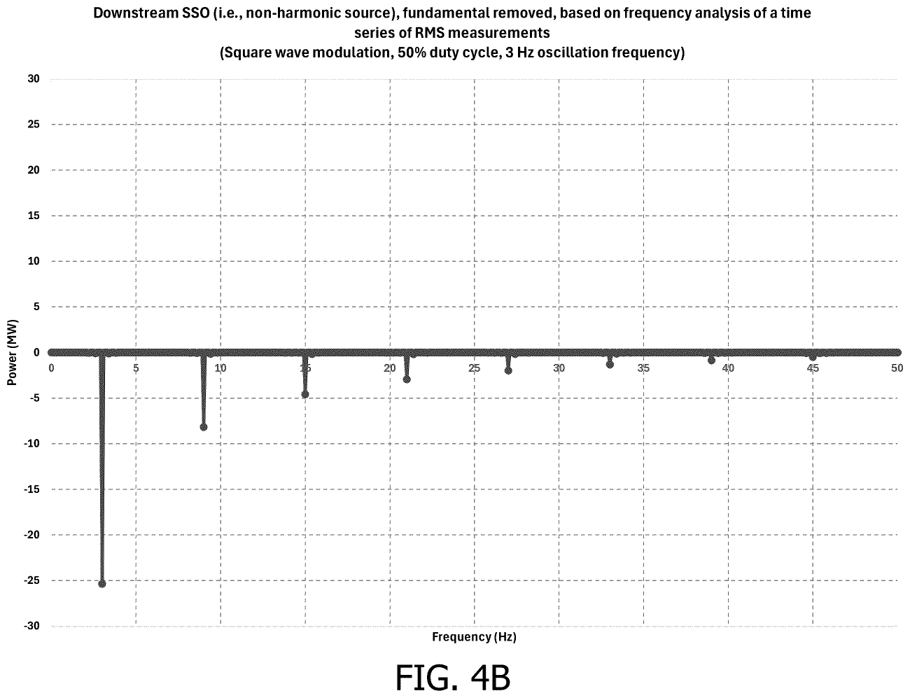

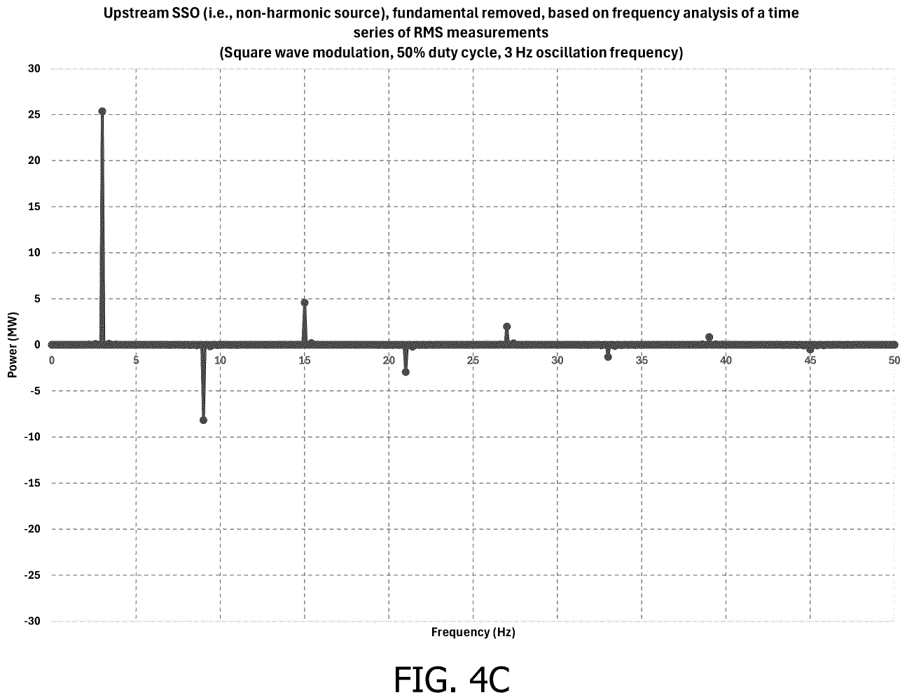

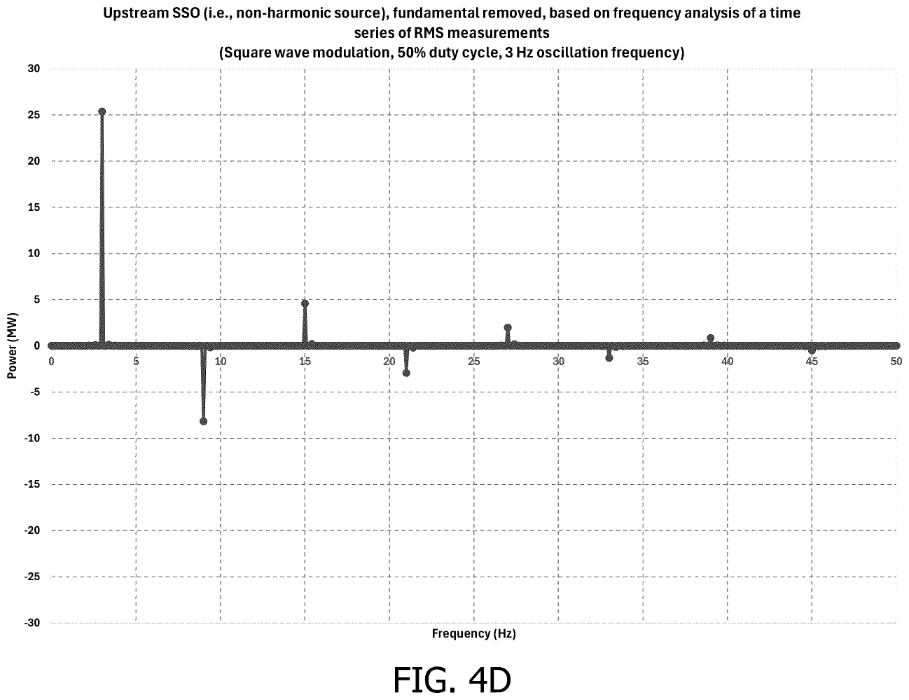

FIG. 4A illustrates an example upstream non-harmonic power flow (non-harmonic event) in accordance with embodiments of the disclosure and FIG. 4B illustrates an example downstream non-harmonic power flow (non-harmonic event) in accordance with embodiments of the disclosure, as produced by the algorithm developed to test aspects of the present disclosure described herein. FIG. 4C illustrates another example upstream non-harmonic power flow in accordance with embodiments of the disclosure and FIG. 4D illustrates another example downstream non-harmonic power flow in accordance with embodiments of the disclosure. FIGS. 4A to 4D illustrate example upstream and downstream non-harmonic power flows having an oscillation frequency of 3 Hz, respectively. Note that the non-harmonic power flows in the illustrated examples also include additional frequencies at 9 Hz, 15 Hz, 21 Hz, 27 Hz, 33 Hz, 39 Hz and 45 Hz. The direction is determined by the sign of the values; positive is upstream and negative is downstream. It is possible to have a single signal with one or more frequencies with power flows going upstream while one or more other frequencies are going downstream.

Advantageously, one or more embodiments provide various benefits. For instance, when installed at the PCC, one or more embodiments help determine whether the source (cause) of non-harmonics is on the utility side or the consumer side of the PCC.

Aspects apply to large customers and utilities that have performance-based contracts in place to ensure levels are kept below some mutually agreed upon threshold. In this case, one or more embodiments resolutely ensure which party is indeed generating the non-harmonics. In addition, when aspects of the present disclosure are incorporated into multiple devices across a power system, the user can decisively determine the location of non-harmonic sources within their facility. This allows the user to more quickly ascertain and mitigate non-harmonic problems in their facility.

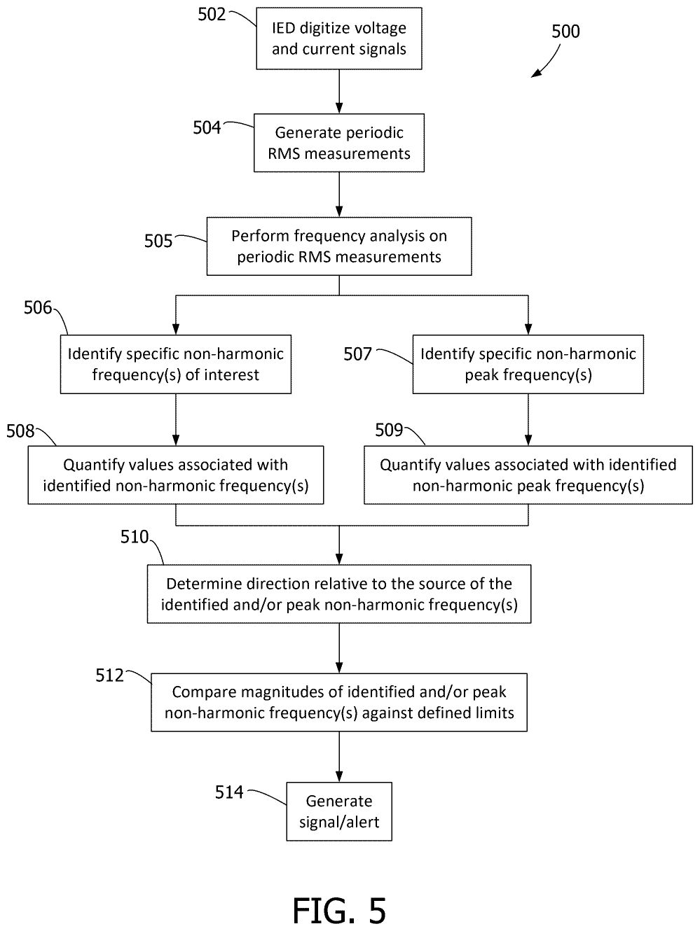

FIG. 5 illustrates an example process 500 for identifying and quantifying sub-synchronous frequencies in an electrical system in accordance with embodiments of the disclosure. Aspects of the present disclosure fit into the following general sequence of elements/steps. Beginning at 502, an IED (e.g., IED 102 of FIG. 1) digitizes a set of voltage and current signals from the electrical system under inspection into a stream of samples. The IED then performs classical analysis on the samples to generate periodic RMS measurements at 504 and, as described below, process 500 performs a frequency analysis on the periodic RMS measurements at 505. According to an embodiment, the measurements include voltage, current, and/or power values on a sliding one-fundamental-cycle time scale. The use of an IED is an existing function of digital power meters that the other features of the present disclosure build upon.

Proceeding to 506, the process 500 identifies a specific non-harmonic frequency(s) or frequency band(s) of interest that may or may not be relevant to sub-synchronous oscillations on the utility (or other) grid. The value or values associated with the identified non-harmonic frequency(s) or frequency band(s) are quantified at 508. At 507, process 500 identifies a specific non-harmonic peak frequency(s) that may or may not be relevant to sub-synchronous oscillations on the utility (or other) grid. The value or values associated with the identified non-harmonic peak frequency(s) are quantified at 509. The quantification can leverage different analysis steps/algorithms, and may be based on measurements such as power, voltage and/or current. In an embodiment, executing a power flow analysis of the quantified values permits determination of a characteristic of the identified one or more non-harmonic frequencies. The determined characteristic comprises at least one of a direction or a magnitude of a power parameter associated with the one or more non-harmonic frequencies of interest, where the power parameter comprises power, energy, current, etc.

The process 500 determines, at 510, the direction to the source (i.e., upstream or downstream with respect to the IED's physical attachment to the circuit) of the identified non-harmonic frequency(s) or frequency band(s) of interest and/or the identified non-harmonic peak frequency(s) using power flow analysis techniques.

Proceeding to 512 the magnitudes of the identified non-harmonic frequency(s) or frequency band(s) of interest and/or the identified non-harmonic peak frequency(s) are compared against a set of identified magnitude limits of concern for each frequency(s) or frequency band(s) to determine if, when (time of occurrence), and for how long the quantified values have exceeded defined limits. In response to the comparison, the process 500 communicates a signal/alert from the IED at 514 to adjust/change/modify/reduce/etc. the characteristics of one or more downstream load(s) to help mitigate/attenuate relevant frequency(s), if at least one of the identified non-harmonic frequency(s) or frequency band(s) are determined to be of sufficient magnitude(s), duration(s) and source location(s) to be of concern. In other words, aspects of the present disclosure may execute a mitigative action, such as one or more of generating an alert, reducing the load, managing loads to balance/adjust/alternate/cycle them in such a way to reduce or minimize the severity of the oscillations, bringing additional sources online (e.g., generators, etc.) to provide different energy sources and (potentially) reduce the SSO effects on the utility, or bringing additional loads online to facilitate “leveling” of the load profile(s), etc.

Referring further to the identification of a specific non-harmonic frequency(s) or frequency band(s) of interest at 506 of FIG. 5 and the identification of a specific non-harmonic peak frequency(s) at 507 of FIG. 5, these frequency(s) are typically below the fundamental system frequency (50 Hz or 60 Hz) for SSO concerns. The specific non-harmonic frequency(s) or frequency band(s) are stored in the IED's memory or elsewhere in the system for use in the measurement and comparison elements described below. The specific non-harmonic frequency(s) or frequency band(s) or specific peak non-harmonic frequency(s) may be highly precise to identify and quantify very specific frequencies of interest, and/or optionally may be wide bands of aggregated sub-fundamental (i.e., non-harmonic) frequencies. The frequency(s) or frequency band(s) of interest may be provided by the utility, customer, or just be “interesting” to consider, and may correspond to resonant frequencies of concern to the health of utility equipment or system interconnection stability.

As an example, the possible frequency band(s) of interest include the three example bands shown below, or are a larger number of more precise bands:
From 0.1 Hz up to 1 Hz: Intra-mode (or inter-area mode) oscillations that can lead to system-wide issues and can cause disruptions across interconnects.
From 1 Hz to 10 Hz: Local mode oscillations that may typically interact with nearby utility equipment but should not cause system-wide interconnect issues. Frequencies of concern would be resonant frequencies specific to the generators and other power system gear.
From 10 Hz to 50 Hz: Local mode oscillations that may typically interact machine to machine inside a plant (intra-plant).

Referring further to the frequency analysis at 505 of FIG. 5, different algorithms may be used for the frequency analysis of the identified measurements. One possible frequency analysis approach uses Fourier Analysis (commonly called an FFT which refers to a specific implementation of Fourier Analysis called the Fast Fourier Transform). Another possible frequency analysis approach uses Goertzel filters/algorithms.

Other known frequency analysis methods or techniques may also be considered, such as analysis of digitally-sampled voltage and current data and analysis of RMS-level power, voltage and/or current data.

Analysis of digitally-sampled voltage and current data according to an embodiment uses the digitized voltage and current samples as inputs to the analysis algorithm, as well as some derived and/or associated metadata. This type of analysis may be performed on relatively short time windows (it is common to use 10/12 cycles which is approximately 200 milliseconds in other frequency analysis on IEDs today). The analysis provides frequent updates but would provide limited frequency resolution (the common use of 10/12-cycle windows will provide a resolution of only 5 Hz).

Analysis of RMS-level power, voltage and/or current data according to an embodiment uses a sequence of calculated RMS values (such as power, voltage and/or current) as inputs to the analysis algorithm, updated one or several times per fundamental cycle. In one example, these inputs may be one-cycle values (more or less) updated every half-cycle (for a 60 Hz system, these inputs are RMS values calculated over windows of approximately 16 milliseconds, updated on a sliding basis approximately every 8 milliseconds). The analysis would typically be done over much longer intervals than the digitally-sampled voltage and/or current inputs (examples may include 10 seconds or even 10 minutes), and provide much more precise frequency resolution, but would be updated less frequently.

Analyzing non-harmonic frequencies (i.e., frequencies less than the system fundamental frequency or nominal frequency) may be performed by capturing and analyzing longer time windows with fewer samples/cycle. The longer the time window captured and analyzed, the more precise the non-harmonic frequency resolution that is achieved. For example, capturing data from a 60 Hz signal at a rate of 2 samples/cycle for a time window of 10 seconds will provide non-harmonic frequencies (<60 Hz) with a resolution of 0.1 Hz.

These algorithms all provide outputs. Some algorithms may provide outputs over the full frequency range of interest (subject to the IED's metering constraints), while other algorithms may provide outputs only over specific frequency sub-ranges. The outputs will typically be arranged into a set of frequency “bins or buckets” at a resolution dictated by the algorithm and the window size (length of time the data is sampled for discrete analysis).

The output bins from the analysis algorithms can be grouped together to align with the identified non-harmonic frequency(s) or frequency band(s) of interest. The output bins themselves may typically represent a large amount of raw data, and it can be more meaningful to aggregate the bins together to align with the frequency(s) or frequency band(s) of interest before moving on to a comparison against limits.

As described above, process 500 identifies specific non-harmonic peak frequency(s) at 507. The value(s) associated with the identified non-harmonic peak frequency(s) are quantified at 509. In an embodiment, aggregating the data of each frequency bin with the data of the two immediately adjacent frequency bins creates a new output data set having a narrowband group magnitude at each of the frequencies of the original output data set. Aggregation in this manner permits identifying and quantifying non-harmonic peak frequency(s). This technique further permits estimating the magnitude of the oscillation at the frequency of the center bin, especially when the oscillation frequency does not precisely align with the frequency resolution steps. This embodiment in which each frequency bin is aggregated with the two immediately adjacent frequency bins is a specific embodiment of the more general embodiment of aggregating data across multiple frequency bins.

Aggregating across three or more bins (e.g., a middle bin plus the two immediately adjacent bins) provides better management of peak detection when a frequency misalignment leads to a wider spectral spread in the measured output data. It is to be understood that aggregation across more bins is expected to provide better results (e.g., aggregating across a total of five bins, namely, the middle bin plus the two pairs of adjacent bins on each side). In another embodiment, the number of bins is not fixed. Instead, dynamically sizing the number of bins for each peak is based on a statistical analysis of the bin data, to intelligently seek real peaks in the data instead of using a statically fixed width. This leads to a more accurate calculation of the real peak magnitudes and improved precision of the frequency calculation. According to one or more embodiments, aggregation across a fixed number of bins, or a dynamically variable number of bins (based on statistical analysis techniques), helps identify the top peaks in the spectral output. In yet another embodiment, the data is aggregated for all frequency bins across the entire defined frequency range for sub-synchronous oscillation (for example, 0.1 Hz to 40 Hz). In accordance with this embodiment, a “total SSO distortion” metric may be created by this aggregation.

Advantageously, the narrowband group magnitude at each of the frequencies of the original output data set may be used for localized peak detection. One method comprises using the output of the narrowband grouping described above but to further assess the highest N non-overlapping narrowband grouped magnitudes (where N is an integer, such as 5, 10, or another number). Another method comprises using an amended narrowband grouping method that leverages a different number of bins than described here (e.g., 3, or 5, or more). Yet another method comprises using a dynamic number of bins based on a statistical analysis of the magnitudes near each center peak.

The output of this analysis can help to quantify the effects of system and/or load operations on specific non-harmonic frequencies.

With respect to the determination of the direction to the source at 510 of FIG. 5, aspects of the present disclosure include identifying a source of a sub-synchronous oscillation (SSO), upstream or downstream, relative to the IED's physical connection point (i.e., where the IED's voltage and current inputs are connected to the electrical conductors in the power system). Power flow analysis methods and techniques often use sampled data analysis (e.g., waveform level analysis) rather than the analysis of a stream of RMS power or current values, as the directional information may benefit from direct analysis of the voltage and current samples.

One benefit of performing sampled data (waveform level) analysis on the voltage and current samples is that this approach preserves phase information for each voltage and current channel at each frequency, which allows a directional analysis for any power flows. Combining the voltage and current vectors at a given frequency using known power analysis methods will result in a signed power value at that frequency. This signed power value according to an embodiment is determined for real and/or reactive power components on each phase of the polyphase system. The sign of the resulting power value indicates the direction of the power flow at that frequency on that phase. This directional data would not be present in the more basic analysis of a stream of RMS power values.

Analysis of a stream of voltage and current samples is typically done for relatively short time windows which corresponds to very limited frequency resolution. Waveform captures typically available from medium to high range meters are one suitable example of this type of sample stream.

The directional information may only be relevant if the frequencies persist over much longer time intervals and may require more precise frequency resolution. It is possible to combine the directional information from the waveform-level analysis of relatively short time windows (for example, 10/12 cycles or approximately 200 milliseconds) with the ability for increased precision and longer duration measurements from the RMS-level analysis of longer time windows (for example, 10 seconds or 10 minutes).

In an embodiment, one approach correlates any spectral content seen in the analysis of a longer time window with the equivalent spectral content seen in the shorter time windows within it, and if a correlation is found to estimate the confidence in any directional information based on how many of the shorter time windows showed the same directional results.

Again, FIGS. 4A to 4D illustrate the upstream and downstream non-harmonic power flows at a frequency of 3 Hz, respectively. Note that the downstream non-harmonic power flows also include additional frequencies at 9 Hz, 15 Hz, 21 Hz, 27 Hz, 33 Hz, 39 Hz, and 45 Hz. The direction is determined by the sign of the values; positive is upstream and negative is downstream. It is possible to have a single signal with one or more frequencies with power flows going upstream while one or more other frequencies are going downstream. The impedances within the electrical system play an important role in the determination of power flow directions.

When non-harmonic frequencies (e.g., an SSO) flow within an electrical system, they may be produced by a load and flow upstream from the customer site to the utility system at certain frequencies, they may be generated somewhere on the utility grid and flow downstream into the customer site at given frequencies (as measured by an IED at the PCC), or some combination thereof. If the non-harmonic power flows into a customer site, they may resonate at different locations within the facility/customer site. Similarly, load(s) producing non-harmonic power flows within a customer site may flow into the utility system, creating issues at discrete locations or areas on the utility system.

Large load-related non-harmonic power flows affiliated/associated with SSO frequencies may intensify SSO-related issues on the utility system. If a critical frequency(s) for oscillations is/are known, it may be possible to shift any exacerbating SSO frequency(s) by providing a “dampening” effect through an adjustment in the offending load(s) operation. For example, the rate at which power/energy is pulsed within a system to serve a load may be affiliated/associated with a known SSO frequency(s). Analyzing the non-harmonics produced within a customer site can allow the customer to vary/adjust the profile of the pulsing, thus shifting the offending non-harmonic(s) away from the SSO frequency(s) identified by the utility. This action is a form of “frequency throttling/shifting.”

In another embodiment, non-harmonic frequency(s) and power flows originating on the utility grid are measured to determine the risk of exacerbating an SSO condition. The power flows at the SSO frequency(s) and measured at the customer site may provide a good indication of the current state of SSO risk on the connected utility grid. If a significant SSO risk is present, “frequency throttling/shifting” may be considered. If a significant SSO risk is NOT present, then the customer site may operate according to their own need/demand.

Referring further to the comparison against a set of identified magnitude limits of concern at 512 of FIG. 5, some oscillation magnitudes will be acceptable within a system, and the thresholds/limits of concern depend on the frequency and on the components within the system. In some cases, relatively large oscillations in the load may still result in acceptable operation. Therefore, it is necessary to identify a set of limits of concern associated with each of the identified discrete non-harmonic frequency(s) or frequency band(s).

For each new analysis iteration, the measurement value for each identified frequency(s) or frequency band(s) are compared against the identified limits of concern. The IED detects and reports if any measurement exceeds the identified limits. The comparison may include an analysis step to wait until a limit has been exceeded for a minimum time duration before reporting the non-compliant result. It is also possible to identify multiple magnitude limits of concern for the same identified non-harmonic frequency(s) or frequency band(s), and to take different actions when each limit is exceeded.

Referring further to communication of a signal/alert from the IED at 514 of FIG. 5, the IED preferably communicates the results of its analysis, as the end benefit to the user is to signal or recommend an action that can be taken to mitigate any concerning frequency content, and to then further monitor the system to confirm the effectiveness of any mitigation measures. System-level analysis according to aspects of the present disclosure includes presenting wider frequency bands to indicate areas of interest, and then “zooming in” to relevant areas of interest. In an embodiment, two different types of analysis measurements are implemented on the same IED, namely, “Early Warning” SSO measurements and “Standard” SSO measurements.

“Early Warning” SSO measurements leverage the existing gapless non-overlapping 10/12-cycle (200 ms) FFTs some existing meters already perform on the voltage/current waveforms, provide sub-second responsiveness to changes but with a low frequency resolution, and consider a single output value covering all relevant frequencies (2.5 Hz to 47.5 Hz). It is to be understood that the values provided below are exemplary.

“Standard” SSO measurements implement a new set of FFTs run on a sequence of half-cycle values for kWₜₒₜ and I_{avg}. Consider a 10 second window size, with a sliding update every 1 second; this will provide sub-10 s responsiveness to changes with a 0.1 Hz frequency resolution. Given the better frequency resolution, these measurements provide a wide set of identified frequency(s) or frequency band(s).

In another embodiment, a third type of analysis measurement comprises “High-Resolution Frequency” SSO measurements. A consideration is whether a customer truly has a specific application need for extra-high frequency resolution (as suggested by a 10-minute FFT window). This analysis implements another set of FFTs run on a sequence of half-cycle values for kWₜₒₜ and I_{avg} but using a much larger window size (for example, 10 minutes); this will provide a much lower responsiveness but will have much more accurate frequency resolution. There is added complexity not just in performing the FFT (which needs to be much larger for such a large window size), but also in managing a much larger output data set. Building useful data visualization/analysis techniques for this potentially large data set is contemplated.

In yet another embodiment, the two primary different types of analysis measurements (“Early Warning” and “Standard” measurements) are combined into a single comprehensive SSO analysis result. This embodiment involves using and/or providing the individual raw 5 Hz bins for the “Early Warning” measurements to correlate the coarse frequency bins (5 Hz, 10 Hz, 15 Hz, 20 Hz, 25 Hz, 30 Hz, 35 Hz, 40 Hz, 45 Hz) with a wider set of frequency bands from the “Standard” measurements. The power flow information from the “Early Warning” results according to an embodiment are used to provide directional information for any sustained oscillations that can be correlated with the higher-resolution results from the “Standard” measurements.

In accordance with one or more embodiments, a Goertzel filter/algorithm may be used. This is a much more efficient method to focus on a limited number of discrete frequencies of concern. However, it would only provide data for the selected frequencies and would not give enough data to fully inspect all frequency bands from 0.1 Hz to 50 Hz. In an embodiment, a high-resolution Goertzel filter for specific frequencies is combined with a lower-resolution FFT across the full SSO bandwidth.

In addition to the identification of and measurement over a set of frequency bands, it may be useful to define a single frequency band across the full SSO bandwidth (which could be called “total SSO distortion” or TSD). A TSD-type measurement is capable of being normalized in different ways, in a similar manner to what is done for THD and thd with harmonic distortion. TSD is provided in engineering units (kW, or A) for an indication of the oscillation's absolute magnitude according to an embodiment. Alternatively, TSD is provided as a normalized value similar to what is often done for THD/thd. “TSD” is provided as a percentage normalized to full-spectrum power in another embodiment, and “TSD” as a percentage normalized to the fundamental 50/60 Hz power.

Another aspect of this embodiment focuses on the magnitude of power flows only at SSO targeted frequency(s). Yet another aspect of this embodiment combines two or more discrete frequencies of interest into a TSD-like measurement, to show the total spectral power over those two or more discrete frequencies of interest. A separate aspect of the present disclosure building on the above is to do something similar for frequencies above the targeted SSO frequency range. For example, to combine two or more discrete frequencies of interest above the fundamental frequency into a THD-like measurement that targets specific frequencies of interest for a given application. Alternatively, a mix of harmonic and non-harmonic frequencies of interest may be examined.

In yet another embodiment, a further analysis looks at SSO energy instead of just looking at SSO power. Considerations for this further analysis involve whether integrating the power over time provides any interesting insights into the cumulative impact of the workload frequencies and whether SSO energy has any practical meaning for a utility. It is contemplated to use SSO energy as an indication of a sustained power oscillation over time (and its impact).

One or more embodiments of the present disclosure employ artificial intelligence/machine learning (AI/ML) approaches to identify unexpected trends of interest in the spectral power for sub-synchronous frequencies. In some data center facilities, the total load is expected to increase significantly, and the magnitude of oscillations could trend upward toward a point of concern over time. The new SSO measurements represent a potentially large set of data, and trends within these data sets may not be obvious until a problem presents itself. Developing automated analysis techniques permits monitoring these data sets for trends of concern, alerting users earlier, and taking mitigative actions before a problem becomes apparent. Directly applying AI/ML techniques to the raw input data to the analysis algorithms described herein also permits identifying other early indicators of emerging SSO patterns. One example may be identifying correlative risks associated with system operations, configurations, time(s) of day/week/year, time(s) of use, utility system load profiles, adjacent, and so forth.

Yet another embodiment executes a statistical analysis approach instead of a frequency analysis approach to more simply try to detect when the power starts to vary unexpectedly. With a set of time-series data as an input (for example, a stream of half-cycle power values), this embodiment involves assessing common statistical metrics such as standard deviation and variance within that data set. In the event it is difficult to identify specific oscillation frequencies with this approach, it could very easily and very quickly show when a load that is normally expected to be highly constant starts to vary. In an embodiment, this is a complementary approach to help flag an emerging issue for further analysis. Inputs from the data center white space processing loads may also be considered (if available).

Aspects of the present disclosure optionally use one or more digital or analog I/O signals to more optimally function. For example, one or more embodiments optionally use a digital status input signal from at least one single-phase or three-phase load (e.g., a polyphase induction motor) to simplify processing and/or enhancing its analysis(es), assessment(s), result(s) and/or recommendation(s). Alternatively, one or more embodiments may use an analog I/O signal from a load(s) (e.g., a polyphase induction motor) to incorporate measured temperatures (i.e., from thermocouple(s)) into its analysis(es), assessment(s), result(s), and/or recommendation(s). I/O signals may be produced or used by at least one of the IEDs, gateways, software systems, cloud-based systems or other applications as necessary. I/O data may be used to indicate a load(s) energizing or de-energizing that may create a disturbance event. If the location of these load(s) is known and the disturbance event directly correlates with their energizing or de-energizing, this information may be used to help determine whether the disturbance event's source or origin is upstream or downstream of one or more IEDs.

It is to be understood that an input is data that a processor and/or IED receives, and an output is data that a processor and/or IED sends. Inputs and outputs may either be digital or analog. The digital and analog signals may be both discrete variables (e.g., two states such as high/low, one/zero, on/off, etc. If digital, this may be a value. If analog, the presence of a voltage/current may be considered by the system/IED as an equivalent signal) or continuous variables (e.g., continuously variable such as spatial position, temperature, pressure voltage, etc.). They may be digital signals (e.g., measurements in an IED coming from a sensor producing digital information/values) and/or analog signals (e.g., measurements in an IED coming from a sensor producing analog information/values). These digital and/or analog signals may include any processing step within the IED (e.g., derive an active power (kW), power factor, a magnitude, a relative phase angle, among all the derived calculations).

Processors and/or IEDs may convert/reconvert digital and analog input signals to a digital representation for internal processing. Processors and/or IEDs may also be used to convert/reconvert internally processed digital signals to digital and/or analog output signals to provide some indication, action, or other response (such as an input for another processor/IED). Typical uses of digital outputs may include signaling relays to open or close breakers or switches, signaling relays to start or stop motors and/or other equipment, and operating other devices and equipment that are able to directly interface with digital signals. Digital inputs are often used to determine the operational status/position of equipment (e.g., is a breaker open or closed, etc.) or read an input synchronous signal from a utility pulsed output. Analog outputs may be used to provide variable control of valves, motors, heaters, or other loads/processes in energy management systems. Finally, analog inputs may be used to gather variable operational data and/or in proportional control schemes.

A few more examples where digital and analog I/O data are leveraged may include (but not be limited to): turbine controls, plating equipment, fermenting equipment, chemical processing equipment, telecommunications, equipment, precision scaling equipment, elevators and moving sidewalks, compression equipment, waste water treatment equipment, sorting and handling equipment, plating equipment temperature/pressure data logging, electrical generation/transmission/distribution, robotics, alarm monitoring and control equipment, as a few examples.

The above-discussed method (and/or other systems and/or methods discussed herein) may include one or more of the following features either individually or in combination with other features in some embodiments. For example, in some embodiments the energy-related signals captured by the at least one IED may include at least one of: a voltage signal, a current signal, an input/output (I/O) data, and a derived energy-related value. In some embodiments, the I/O data includes at least one of on/off status(es), open/closed status(es), high/low status(es), temperature(s), pressure(s), and volume(s). Additionally, in some embodiments the derived energy-related value includes at least one of: a calculated, computed, estimated, derived, developed, interpolated, extrapolated, evaluated, and otherwise determined additional energy-related value from the at least one of the voltage signal and/or the current signal. In some embodiments, the derived energy-related value includes at least one of: active power, apparent power, reactive power, energy, harmonic distortion, power factor, magnitude/direction of harmonic power(s), harmonic voltage(s), harmonic current(s), non-harmonic current(s), non-harmonic voltage(s), magnitude/direction of non-harmonic power(s), magnitude/direction of non-harmonic power(s), individual phase currents, phase angle(s), impedance(s), sequence component(s), total voltage harmonic distortion, total current harmonic distortion, three-phase current(s), phase voltage(s), line voltage(s) and/or other similar/related parameters. In some embodiments, the derived energy-related value includes at least one energy-related characteristic, the energy-related characteristic including magnitude, direction, phase angle, percentage, ratio, level, duration, associated frequency components, impedance, energy-related parameter shape, and/or decay rate. It is understood that the energy-related signals may include (or leverage) substantially any electrical parameter derived from at least one of the voltage and current signals (including the voltages and currents themselves), including, for example, load levels and patterns, as will be understood from further discussions below.

In some embodiments, the above-discussed method (and/or other system(s) and/or method(s) discussed herein) may be implemented on the at least one IED called for in the above-discussed method (and/or other systems and/or methods discussed herein). Additionally, in some embodiments the above-discussed method (and/or other systems and/or methods discussed herein) may be implemented partially or fully remote from the at least one IED, for example, in a gateway, on-site software, edge software, a remote server, etc. (which may collectively or alternatively be referred to herein as a “head-end” system). It is to be understood that “cloud-based software,” “edge software,” “edge system,” “management system,” “software management system,” etc. may collectively or alternatively be referred to herein as “head-end software” generally (for the purposes of this application). In some embodiments, the at least one IED may be coupled to measure energy-related signals, receive electrical measurement data from or derived from the energy-related signals at an input, and configured to generate at least one or more outputs. The outputs may be used to identify the at least one potential load type associated with the characterized and/or quantified at least one identified variation/change in the electrical system. Examples of the at least one IED may include a smart utility meter, a power quality meter, and/or another measurement device (or devices). The at least one IED may include breakers, relays, power quality correction devices, uninterruptible power supplies (UPSs), filters, and/or variable speed drives (VSDs), for example. Additionally, the at least one IED may include at least one virtual (e.g., residual energy-related signal measurement, calculation, or derivation) meter in some embodiments.

In some embodiments, the energy-related signals may be continuously or semi-continuously captured and/or logged by the at least one IED, and variation(s)/change(s) identified in the energy-related signals may be updated (e.g., evaluated/re-evaluated, prioritized/re-prioritized, tracked, etc.) in response thereto. For example, variation(s)/change(s) may initially be identified from energy-related signals captured at a first time and may be updated or revised in response to (e.g., to include or incorporate) variation(s)/change(s) identified from energy-related signals captured at a second time. As variation(s)/change(s) are identified, the variation(s)/change(s) may be characterized and/or quantified, information related to the characterized and/or quantified identified variation(s)/change(s) may be appended to time-series information associated with energy-related data, and characteristics and/or quantities associated with the time-series information may be evaluated to identify at least one potential load type associated with the characterized and/or quantified identified variation(s)/change(s), for example. The appended information may include, for example, tagged indications on the time-series information, metadata, characteristics and/or other information related to the characterized and/or quantified identified variation(s)/change(s).

As used herein, the terms “upline” and “downline” (also sometimes referred to as “upstream” and “downstream”, respectively) are used to refer to electrical locations within an electrical system. More particularly, the electrical locations “upline” and “downline” are relative to a physical location of an IED connection used to collect data and provide this information. For example, in an electrical system including a plurality of IEDs, one or more IEDs may be positioned (or installed) at an electrical location that is upline relative to one or more other IEDs in the electrical system, and the one or more IEDs may be positioned (or installed) at an electrical location that is downline relative to one or more further IEDs in the electrical system. A first IED or load that is positioned on an electrical circuit upline from a second IED or load may, for example, be positioned electrically closer to an input or source of the electrical system (e.g., an electrical generator or a utility feed) than the second IED or load. Conversely, a first IED or load that is positioned on an electrical circuit downline from a second IED or load may be positioned electrically closer to an end or terminus of the electrical system than the other IED (so in this case, it will be closer to a load or group of loads).

A first IED or load that is electrically connected in parallel (e.g., on an electrical circuit) with a second IED or load may be considered to be “electrically” upline from said second IED or load in embodiments, and vice versa. In embodiments, algorithm(s) used for determining a direction of a power quality event (i.e., upline or downline) is/are located (or stored) in the IED, cloud, on-site software, gateway, etc. As one example, the IED can record an electrical event's voltage and current phase information (e.g., by sampling the respective signals) and communicatively transmit this information to a cloud-based system. The cloud-based system may then analyze the voltage and current phase information (e.g., instantaneous, root-mean-square (rms), waveforms and/or other electrical characteristic) to determine if the source/origin of an energy-related transient (or other energy-related event) is electrically upline or downline from where the IED is electrically coupled to the electrical system (or network).

In some embodiments, the energy-related data from or derived from the energy-related signals captured by the at least one IED is processed on at least one of: the IED, the cloud-based system, the on-site or edge software, the gateway, and the other head-end system associated with the electrical system. In these embodiments, for example, the at least one IED may be communicatively coupled to the at least one of: the cloud-based system, the on-site or edge software, the gateway, and any other head-end system on which the electrical measurement data is processed, analyzed, and/or displayed.

In some embodiments, data associated with the energy-related data is stored (e.g., in a memory device of at least one device or system associated with the electrical system) and/or tracked over a predetermined time period. The predetermined time period may be a user-configured time period, for example. In some embodiments, the stored and/or tracked data includes information associated with identifying the at least one potential load type. The information associated with identifying the at least one potential load type may include, for example, at least one of: the at least one identified variation/change, the characterized and/or quantified at least one identified variation/change, the time-series information, and the evaluated characteristics and/or quantities associated with the time-series information. In some embodiments, the information associated with identifying the at least one potential load type may be saved and/or tracked for future analyses/uses. For example, the stored and/or tracked information may be used to generate a library of load types and associated start/run/change/stop characteristics and/or be added to a pre-existing library of load types and associated start/run/change/stop characteristics. In embodiments in which there is a pre-existing library of load types and associated start/run/change/stop characteristics, the at least one potential load type identified using the systems and methods described herein may be selected from a plurality of potential loads types in the pre-existing library of load types and associated start/run/change/stop characteristics.

In some embodiments, the above-described system may correspond to a control system (e.g., the previously discussed control system) used for monitoring or controlling one or more parameters associated with the electrical system. As previously discussed, in some embodiments, the control system may be a meter, an IED (e.g., of the at least one IED responsible for capturing the energy-related signals), programmable logic controller (PLC), head-end software (e.g., edge software system), a cloud-based control system, a gateway, a system in which data is routed over the Ethernet or some other communications system, etc.

It is understood that the systems and methods described herein may be responsive to changes in the electrical system(s) in which the systems and methods are provided and/or implemented. For example, the prescribed threshold or thresholds that the at least one identified variation/change is compared to determine if the at least one identified variation/change meets the prescribed threshold or thresholds, may be a dynamic threshold or thresholds that change in response to changes in the electrical system(s). The changes in the electrical system(s) may be detected, for example, from the energy-related signals captured by the at least one IED in the electrical system(s). In one example implementation, the changes are detected after manually training/teaching a system to identify the changes. For example, the specific equipment (or processes) operating at a given time may be described to allow the system to learn (i.e., a form of machine learning). In another example implementation, the changes are detected by automatically identifying operational modes using state of the art machine learning algorithms (e.g., using time series clustering or using spectral or any other algorithms helpful in analysis to identify patterns).

As will become further appreciated from discussions herein, the disclosed embodiments provide, among other features, the ability to characterize voltage, current, and other derived signals to better understand upstream and downstream loads, their operation(s) and impact(s) to the electrical system. The ability to automatically evaluate energy-related data to associate, characterize, quantify, identify, and analyze helps end-users to better understand the operation of their electrical system. It may also provide many more services and solutions opportunities to energy-related companies, such as Schneider Electric, the assignee of the present disclosure.

It is understood that the at least one energy-related waveform capture described in connection with the above method (and the other methods and systems discussed below) may be associated with energy-related signals captured or measured by the at least one IED. For example, in accordance with some embodiments of this disclosure, the at least one energy-related waveform capture may be generated from at least one energy-related signal captured or measured by the at least one IED. According to IEEE Standard 1057-2017, for example, a waveform is “[a] manifestation or representation (e.g., graph, plot, oscilloscope presentation, discrete time series, equations, table of coordinates, or statistical data) or a visualization of a signal.” With this definition in mind, the at least one energy-related waveform may correspond to a manifestation or representation or a visualization of the at least one energy-related signal. It is understood that the above relationship is based on one standards body's (IEEE in this case) definition of a waveform, and other relationships between a waveform and a signal are of course possible, as will be understood by one of ordinary skill in the art.

It is understood that the energy-related signals or waveforms captured or measured by the at least one IED may include (or leverage) substantially any electrical parameter derived from at least one of the voltage and current signals (including the voltages and currents themselves), for example. It is also understood that the energy-related signals or waveforms may be continuously or semi-continuously/periodically captured/recorded and/or transmitted and/or logged by the at least one IED. As noted above, the at least one captured energy-related waveform may be analyzed (e.g., in real-time, pseudo-real time, or historically) to determine if the at least one captured energy-related waveform is capable of being compressed, while maintaining relevant attributes for characterization, analysis and/or other use.

In some embodiments, the at least one IED capturing the energy-related waveforms includes at least one metering device. The at least one metering device may correspond, for example, to at least one metering device in the electrical system for which the energy-related waveforms are being captured/monitored.

It is understood that the terms “processor” and “controller” are sometimes used interchangeably herein. For example, a processor may be used to describe a controller. Additionally, a controller may be used to describe a processor.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device and are executed by a data processor(s) of the device.

Although described in connection with an example computing system environment, embodiments of the aspects of the disclosure are operational with other special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored in memory, i.e., one or more tangible, non-transitory storage media, and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the disclosure.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that at least some embodiments help to address at least some concerns discussed herein and that at least some embodiments help achieve and attain one or more advantageous results.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method for detecting sub-synchronous oscillations in an electrical system, the method comprising:
acquiring, by at least one Intelligent Electronic Device (IED) of an electrical system, energy-related signals associated with the electrical system;
processing the energy-related signals to identify one or more non-harmonic frequencies of interest in the energy-related signals;
in response to the processing, quantifying values associated with the identified one or more non-harmonic frequencies of interest as a function of at least one of power, voltage, or current data in the energy-related signals;
executing a power flow analysis of the quantified values to determine a characteristic of the identified one or more non-harmonic frequencies of interest relative to the IED; and
executing a mitigative action in response to the quantified values exceeding a set of predefined magnitude limits for longer than a duration threshold.

2. The method of claim 1, wherein the one or more frequencies of interest are below a fundamental system frequency.

3. The method of claim 1, wherein the one or more frequencies of interest comprise one or more frequency bands.

4. The method of claim 3, wherein at least one of the one or more frequency bands includes intra-mode oscillations.

5. The method of claim 3, wherein at least one of the one or more frequency bands includes local mode oscillations.

6. The method of claim 1, wherein quantifying the values associated with the identified one or more non-harmonic frequencies of interest comprises executing one or more of a Fourier analysis or a Goertzel algorithm.

7. The method of claim 1, wherein quantifying the values associated with the identified one or more non-harmonic frequencies of interest comprises capturing and analyzing longer time windows with fewer samples/cycle.

8. The method of claim 1, further comprising grouping the identified one or more non-harmonic frequencies of interest in bins at a predefined resolution.

9. The method of claim 1, wherein the mitigative action comprises generating an alert communicating information relating to changing a load downstream of the IED to mitigate characteristics of the identified one or more non-harmonic frequencies of interest.

10. The method of claim 1, further comprising identifying a source of a sub-synchronous oscillation (SSO) upstream or downstream relative to the IED.

11. The method of claim 1, wherein processing the energy-related data to identify the one or more non-harmonic frequencies of interest comprises grouping the at least one of power, voltage, or current data in the energy-related signals in one or more frequency bins.

12. The method of claim 11, wherein quantifying values associated with the identified one or more non-harmonic frequencies of interest includes aggregating the data in two or more of the frequency bins.

13. The method of claim 12, wherein aggregating the data in two or more of the frequency bins comprises aggregating the data of each frequency bin with the data of two immediately adjacent frequency bins and creating a new output data set having a narrowband group magnitude at each of the frequencies of the original output data set.

14. The method of claim 13, further comprising identifying a localized peak frequency as a function of the narrowband group magnitude at each of the frequencies of the original output data set, wherein the localized peak frequency is defined as a highest predetermined number of non-overlapping narrowband group magnitudes.

15. The method of claim 11, further comprising correlating the frequency bins for early warning measurements with a wider set of frequency bands for higher resolution standard measurements, wherein power flow information from the early warning measurements provide directional information for a sub-synchronous oscillation (SSO) correlated with the higher-resolution standard measurements.

16. The method of claim 1, wherein the determined characteristic comprises at least one of a direction or a magnitude of a power parameter associated with the one or more non-harmonic frequencies of interest.

17. A system for detecting sub-synchronous oscillations comprising:
at least one Intelligent Electronic Device (IED) communicatively coupled to an electrical system, the IED configured to acquire energy-related signals associated with the electrical system;
a meter processor receiving and responsive to the energy-related signals acquired by the at least one IED; and
a memory coupled to the meter processor, the memory storing processor-executable instructions that, when executed, configure the meter processor to:
process the energy-related data to identify one or more non-harmonic frequencies of interest in the energy-related signals;
in response to identifying the one or more non-harmonic frequencies of interest, quantify values associated with the identified one or more non-harmonic frequencies of interest as a function of at least one of power, voltage, or current data in the energy-related signals;
execute a power flow analysis of the quantified values to determine a characteristic of the identified one or more non-harmonic frequencies of interest relative to the IED; and
executing a mitigative action in response to the quantified values exceeding a set of predefined magnitude limits for longer than a duration threshold.

18. The system of claim 17, wherein the one or more frequencies of interest are below a fundamental system frequency.

19. The system of claim 17, wherein the one or more frequencies of interest comprise one or more frequency bands.

20. The system of claim 19, wherein at least one of the one or more frequency bands includes intra-mode oscillations.

21. The system of claim 19, wherein at least one of the one or more frequency bands includes local mode oscillations.

22. The system of claim 17, wherein the processor-executable instructions comprise one or more of a Fourier analysis or a Goertzel filter for quantifying the values associated with the identified one or more non-harmonic frequencies of interest.

23. The system of claim 17, wherein the mitigative action comprises an alert communicating information relating to changing a load downstream of the IED to mitigate characteristics of the identified one or more non-harmonic frequencies of interest.

24. The system of claim 17, wherein the at least one of power, voltage, or current data in the energy-related signals are grouped in one or more frequency bins when identifying the one or more non-harmonic frequencies of interest.

25. The system of claim 24, wherein the memory stores processor-executable instructions that, when executed, further configure the meter processor to aggregate the data in two or more of the frequency bins.

26. The system of claim 25, wherein the memory stores processor-executable instructions that, when executed, further configure the meter processor to aggregate the data of each frequency bin with the data of two immediately adjacent frequency bins and create a new output data set having a narrowband group magnitude at each of the frequencies of the original output data set.

27. The system of claim 26, wherein the memory stores processor-executable instructions that, when executed, further configure the meter processor to identify a localized peak frequency as a function of the narrowband group magnitude at each of the frequencies of the original output data set, wherein the localized peak frequency is defined as a highest predetermined number of non-overlapping narrowband group magnitudes.

28. The system of claim 24, wherein the memory stores processor-executable instructions that, when executed, further configure the meter processor to correlate the frequency bins for early warning measurements with a wider set of frequency bands for higher resolution standard measurements, wherein power flow information from the early warning measurements provide directional information for a sub-synchronous oscillation (SSO) correlated with the higher-resolution standard measurements.

29. The system of claim 17, wherein the determined characteristic comprises at least one of a direction or a magnitude of a power parameter associated with the one or more non-harmonic frequencies of interest.
